(19) United States
(12) Patent Application Publication
(10) Pub. No.: US 2008/0046608 A1
(43) Pub. Date: Feb. 21, 2008

(54) Low-Power Extended USB Flash Device Without Polling

(75) Inventors: Charles C. Lee, Cupertino, CA (US); David Q. Chow, San Jose, CA (US); Abraham C. Ma, Fremont, CA (US); Frank Yu, Palo Alto, CA (US); Ming-Shiang Shen, Taipei Hsien (TW); Horng-Yee Chou, Superior, CO (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 11/925,933

(22) Filed: Oct. 27, 2007

Related U.S. Application Data
(63) Continuation-in-part of application No. 09/478,720, filed on Jan. 6, 2000, now Pat. No. 7,257,714.
(63) Continuation-in-part of application No. 11/624,667, filed on Jan. 18, 2007.
(63) Continuation-in-part of application No. 11/864,696, filed on Sep. 28, 2007.
(63) Continuation-in-part of application No. 09/366,976, filed on Aug. 4, 1999, now Pat. No. 6,547,130.
(63) Continuation-in-part of application No. 10/854,004, filed on May 25, 2004.
(63) Continuation-in-part of application No. 10/708,096, filed on Feb. 9, 2004, now Pat. No. 7,130,958.
(63) Continuation-in-part of application No. 10/707,138, filed on Nov. 22, 2003, now abandoned.

(51) Int. Cl. G06F 3/00

(52) U.S. Cl. 710/30

(57) ABSTRACT

An extended Universal-Serial Bus (EUSB) host enters a suspend mode rather than poll an EUSB device that is busy performing a memory or other operation. Power is saved since polling is avoided. The busy EUSB device sends a not-yet NYET signal back to the EUSB host to instruct the host to enter the suspend mode. When the EUSB device is ready to continue transfer with the host, the EUSB device wakes up the host by sending a ready RDY signal back to the host. The NYET and RDY signals may be tokens or flags in serial packets sent over a full-duplex connection to the host with two sets of differential pairs. Transfers may be re-started by the host after suspension once the requested data is read from flash memory, or space is made available in a sector buffer by completing earlier writes to flash memory.

### RELATED APPLICATIONS

This application is a continuation-in-part (CIP) of the co-pending application “Backward Compatible Extended-MLC USB Plug And Receptacle with Dual Personality”, U.S. application Ser. No. 11/864,696 filed Sep. 28, 2007, which is a CIP of “Extended Secure-Digital (SD) Card Devices and Hosts”, U.S. application Ser. No. 10/854,004 filed May 25, 2004. This application is also a CIP of “Serial Interface to Flash Memory Chip using PCI-Express-Like Packets and Packed Data for Partial-Page Writes”, U.S. application Ser. No. 10/708,096 filed Feb. 9, 2004, and is a CIP of the U.S. patent application for “Expresscard with On-Card Flash Memory with Shared Flash Control Bus but Separate Ready Lines”, U.S. Ser. No. 10/707,138, filed Nov. 22, 2003.

This application is also a continuation-in-part (CIP) of the co-pending application for “Electronic Data Storage Medium with Fingerprint Verification Capability”, U.S. Ser. No. 11/624,667 filed Jan. 18, 2007, which is a divisional application of U.S. patent application Ser. No. 09/478,720, filed on Jan. 6, 2000, which has been petitioned to claim the benefit of CIP status of one of inventor's earlier U.S. patent applications for “Integrated Circuit Card with Fingerprint Verification Capability”, U.S. application Ser. No. 09/366,976, filed Aug. 4, 1999, now issued as U.S. Pat. No. 6,547,130.

### FIELD OF THE INVENTION

This invention relates to extended Universal-Serial Bus (USB) systems, and more particularly to lower-power USB protocol extensions that reduce power.

### BACKGROUND OF THE INVENTION

A great variety of small portable devices such as personal digital assistants (PDA), multi-function cell phones, digital cameras, music players, etc. have become widely available. These devices use a central processing unit (CPU) or microcontroller and a mass-storage memory such as a hard drive or flash memory. These small devices are often cost and size sensitive.

Hard disks and other mass storage devices are being replaced or supplemented with solid-state mass storage such as flash memories. Flash memories use non-volatile memory cells such as electrically-erasable programmable read-only memory, (EEPROM), but are not randomly accessible at the byte level. Instead, whole pages or sectors of 512 bytes or more are read or written together as a single page. NAND flash memory is commonly used for data storage of blocks. Pages in the same block may have to be erased together, and limitations on writing may exist, such as only being allowed to write each page once between erases.

These small portable electronic devices often are able to connect to a host computer such as a personal computer (PC). While a proprietary connector may be used, a connector for a standard expansion bus is preferable. Universal-Serial Bus (USB) is often used to connect such portable flash-memory devices to a PC.

USB uses one pair of differential lines that are time-duplexed, or used for transmission in both directions, but at different times. This may limit performance when data needs to be sent in both directions at the same time. The current USB 2.0 standard provides that the host, such as the PC, controls the bus as the bus master, while USB devices plugged into the host act as slave devices. A USB controller on the host PC generates data transfer transactions and waits for USB devices to respond, either by transmitting requested data to the host, or by writing host data into the USB device's memory.

Since memory on a USB device may be busy or slow, sometimes the host's request cannot be processed immediately. The host may send the request, then periodically poll the USB device to see whether the data is ready. Also, when the host is idle, the host may need to periodically poll the USB device to see if the USB device needs to transfer information to the host. This periodic polling may be used for other purposes as well, such as for polling a mouse for movement.

While polling is useful, since it allows the host to completely control the USB bus, power is consumed each time a packet is sent for polling. While this power is small, for low-power or battery-powered devices, the amount of power consumed may be significant and undesirable. Also, the USB device or host may otherwise be in a low-power sleep or suspend state, and have to wake up into a higher-power state to perform or respond to the polling. There may be significant time and energy required to wake up from the suspend or sleep state, and then to re-enter the suspend or sleep state once polling is done.

What is desired is a USB device and USB host that have lower power. A USB system that does not require polling is desirable. Bus protocols and transactions that avoid polling are desirable to be applied to USB to reduce energy consumed by polling.

### BRIEF DESCRIPTION OF THE DRAWINGS

FIG. 1 is a block diagram of a simplified host and device connected with an extended Universal-Serial Bus (EUSB).

FIG. 2 shows an extended USB device connected to a EUSB host.

FIG. 3 is a flow diagram highlighting reading of an EUSB device without polling.

FIG. 4 is a flow diagram highlighting writing to an EUSB device without polling.

FIGS. 5A-B are packet-timing diagrams showing sequences of packets being sent to and received from the EUSB device.

FIG. 6 is a flowchart of a basic IN protocol flow with not-acknowledge (NACK) to avoid polling.

FIG. 7 is a flowchart of a basic OUT protocol flow with not-acknowledge (NACK) to avoid polling.

FIGS. 8A-B show a flowchart of an EUSB host suspending while an EUSB device is busy during an IN transfer.

FIGS. 9A-B show a flowchart of an EUSB host suspending while an EUSB device is busy during an OUT transfer.

FIG. 10 is a block diagram of host with a EUSB receptacle that supports single-mode EUSB communication.

### DETAILED DESCRIPTION

The present invention relates to an improvement in Universal-Serial Bus (USB) devices and hosts. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

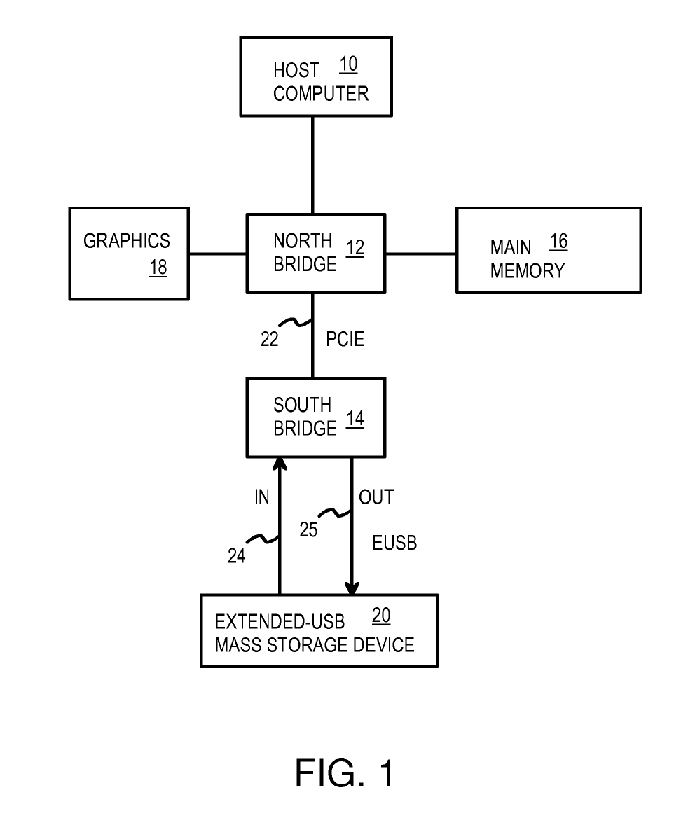

FIG. 1 is a block diagram of a simplified host and device connected with an extended Universal-Serial Bus (EUSB). Host computer 10 executes instructions including those in user and application programs, operating systems, device drivers, and other applets. Main memory 16 may be a dynamic random-access memory (DRAM) or other kind of RAM that stores instructions and data that is accessed by the central processing unit (CPU) in host computer 10.

North bridge 12 contains bus and memory controllers that generate control signals of the proper timing to main memory 16 and to graphics system 18. North bridge 12 also contains a Peripheral Components Interconnect Express (PCIE) controller that generates transactions on PCIE bus 22.

PCIE bus 22 connects north bridge 12 to south bridge 14. South bridge 14 also contains bus controllers and bus logic. An extended Universal-Serial Bus (EUSB) controller in south bridge 14 converts PCIE transactions into EUSB transactions that are sent to EUSB device 20 over the EUSB bus. However, rather than time-duplex a single differential pair of lines, two differential pairs are provided, allowing full-duplex data transfers. OUT differential pair 25 can be sending data from the host to EUSB device 20 at the same time that IN differential pair 24 is sending data read from EUSB device 20 back to host computer 10. Thus EUSB device 20 provides a higher performance than an ordinary USB 2.0 device that is only half-duplex.

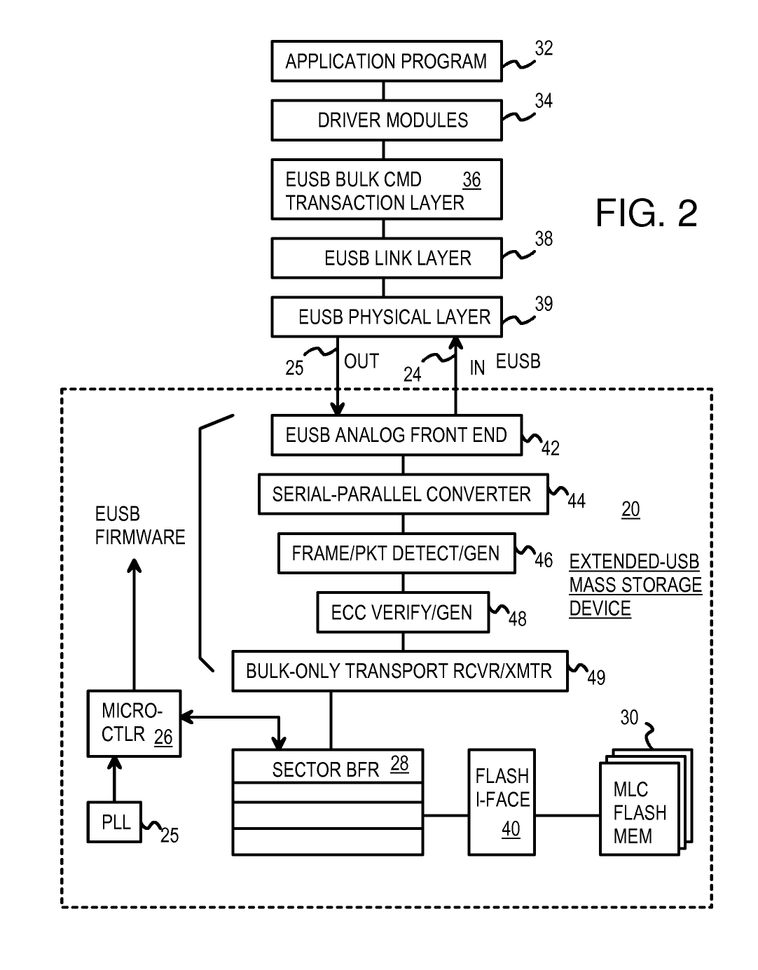

FIG. 2 shows an extended USB device connected to a EUSB host. Application program 32 on a host needs to read data that is stored in flash memory 30 on EUSB device 20. Application program 32 sends a data-read request to a device driver for the flash in device modules 34, which activate EUSB bulk-only-transfer and command transaction layer 36. EUSB bulk-only-transport and command transaction layer 36 embed a read command inside a EUSB data payload and header using the bulk-only-transport mode of USB. A cyclical-redundancy-check (CRC) checksum is also attached.

EUSB link layer 38 adds a sequence number and another CRC checksum, while EUSB physical layer 39 adds packet framing and performs 8/10-bit encoding. The framed data packet is sent from the host to EUSB device 20 over OUT differential pair 25.

EUSB analog front end 42 senses the data transitions on OUT differential pair 25, extracts the clock, and sends serial data to serial-parallel converter 44, which generates parallel data words. The parallel data words are examined by frame and packet detector 46 to locate frame and packet boundaries. The header and data payload can be located by bulk-only-transport receiver 49, ECC generator/checker 48 checks CRC's for error detection. The data payloads can be written into sector buffer 28.

Microcontroller 26 examines the headers and data payloads from bulk-only-transport receiver 49 and detects the read command. Microcontroller 26 activates flash interface 40 to perform a read of flash memory 30, and the flash data read is transferred into sector buffer 28. This flash data in sector buffer 28 is formed into data payloads, a header attached by bulk-only-transport receiver 49, and passed back down the layers for transmission to the host over IN differential pair 24.

Phase-locked loop (PLL) 25 may be driven by an external crystal (not shown) and generates an internal clock to microcontroller 26 and other components such as sector buffer 28. Microcontroller 26 controls operation of EUSB firmware that may include bulk-only-transport receiver 49, ECC generator/checker 48, frame and packet detector 46, serial-parallel converter 44, and EUSB analog front end 42.

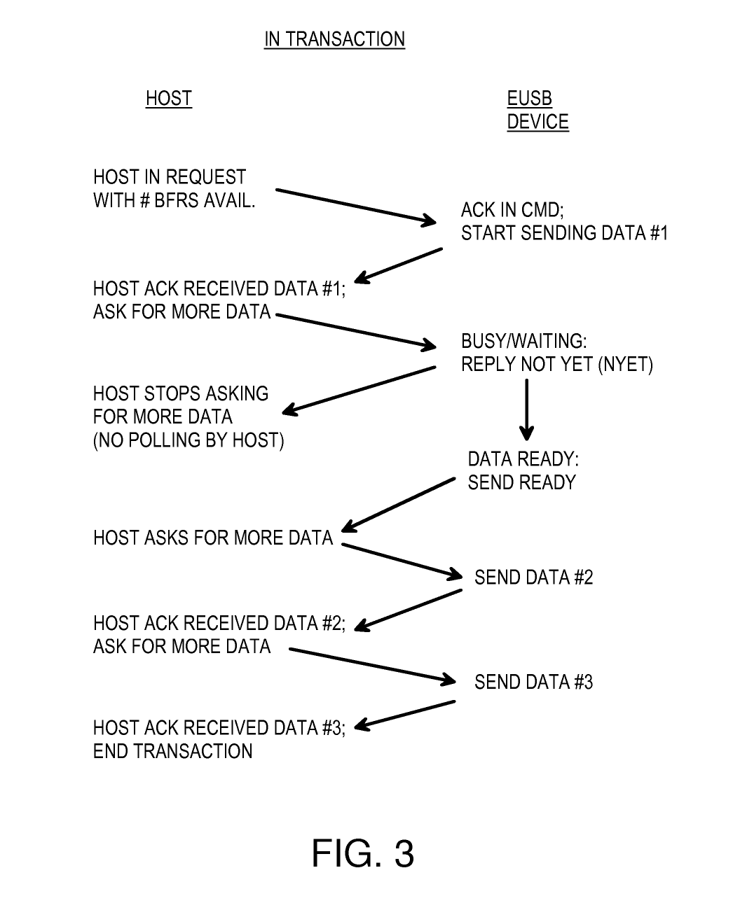

FIG. 3 is a flow diagram highlighting reading of an EUSB device without polling. When the EUSB device is not yet ready to send data to the host, the EUSB device asserts a not yet (NYET) signal to the host. When the EUSB device is ready again to send data, it asserts a ready (RDY) signal to the host, and de-asserts the NYET signal.

The addition of the NYET and RDY signals allows the host to simply monitor these signals to detect when the EUSB device is ready to continue sending data. With the NYET signal, the host no longer has to continuously poll the USB device to determine when the data is ready for transmission.

The host is still the bus master and initiates a transfer by sending a packet with the IN request to the EUSB device. The request also contains a number that indicates a number of buffers available in the host, or the number of packets that can be accepted by the host. Other information such as a device identifier or address of the EUSB device can be included in the IN request packet.

The EUSB device receives the IN request packet and sends an acknowledgement ACK back to the host to acknowledge the IN command. The EUSB device also starts reading the requested data and sending the first part of that data when available. This is data packet #1.

The host acknowledges receipt of data packet #1 by sending an ACK packet back to the EUSB device. This ACK packet implicitly also request that the next data packet be sent. However, the EUSB device is not yet ready to send the second data packet, data #2. Perhaps the reading of the flash memory is delayed, or data #2 is not cached while data #1 was cached by the flash controller. The busy EUSB device sends a NYET packet back to the host to indicate that the data is not yet ready.

In response to the NYET packet, the host stops asking for more data. The host does not poll the EUSB device. Instead, the host simply waits. The host may even enter a lower-power state such as a suspend or sleep state.

The EUSB device eventually reads the data, and stores the data in its sector buffer or in another memory buffer. A ready RDY signal is generated to the host, while the NYET signal is de-asserted. The NYET, RDY, and ACK signals may be flags in a packet header that are set or cleared, such as a status packet or a data packet. Thus separate signal lines to the host are not required, and the NYET, RDY, and ACK signals may be carried over the differential pair signal lines with the header, data payloads, framing, and other information in the data stream.

The host responds to the RDY signal by asking for more data to be sent. The EUSB then forms the data into a packet as data #2, which is sent to the host. The host acknowledges receipt of data #2, and asks for more data. The EUSB device then sends data #3, which the host acknowledges. When the initial IN request had a number of buffers equal to 3, then all requested data is received by the host, and the IN transaction ends.

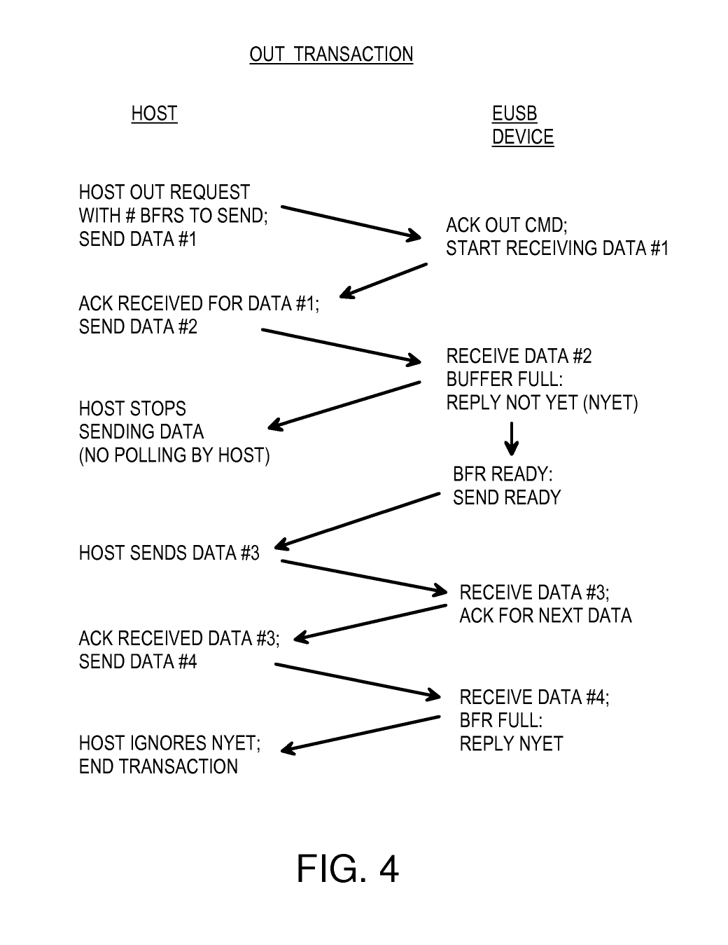

FIG. 4 is a flow diagram highlighting writing to an EUSB device without polling. When writing to the EUSB device, data is buffered in a sector buffer, such as sector buffer 28 (FIG. 2). The physical writing to the flash memory may be quite slow. Thus sector buffer 28 may fill up before the data can be written to flash memory and deleted from sector buffer 28. When sector buffer 28 is full, the host must stop sending more data, since there is no place to store this additional data. A buffer overflow may otherwise occur.

When sector buffer 28 is full, the EUSB device is not yet ready to receive more data from the host. The EUSB device asserts a not yet (NYET) signal to the host. When the EUSB device is ready again to receive data, it asserts a ready (RDY) signal to the host, and de-asserts the NYET signal.

The addition of the NYET and RDY signals allows the host to simply monitor these signals to detect when the EUSB device is ready to continue receiving data. With the NYET signal, the host no longer has to continuously poll the USB device to determine when the data may be transmitted.

The host is still the bus master and initiates a transfer by sending a packet with the OUT request to the EUSB device. The request also contains a number that indicates a number of buffers or packets of data from the host. Other information such as a device identifier or address of the EUSB device can be included in the OUT request packet.

The EUSB device receives the OUT request packet and sends an acknowledgement ACK back to the host to acknowledge the OUT command. The EUSB device also starts receiving and buffering the requested data. This is data packet #1.

The EUSB device acknowledges receipt of data packet #1 by sending an ACK packet back to the host. This ACK packet implicitly also request that the next data packet be sent. The host responds by sending data packet #2.

However, the buffer on the EUSB device fills up after receiving data packet #2. The EUSB device is busy writing the buffered data to the flash memory and must wait until this writing is complete and space is made available in the second buffer. The busy EUSB device sends a NYET packet back to the host to indicate that the EUSB device is not yet ready to receive more data.

In response to the NYET packet, the host stops sending more data. The host does not poll the EUSB device. Instead, the host simply waits. The host may even enter a lower-power state such as a suspend or sleep state.

The EUSB device eventually writes the data, and more space is made available in its sector buffer or in another memory buffer. A ready RDY signal is generated to the host, while the NYET signal is de-asserted.

The host responds to the RDY signal by sending more data to the EUSB device. The EUSB receives the data as data #3. The EUSB device acknowledges receipt of data #3, and asks for more data. The host then sends data #4, which the EUSB device acknowledges. However, the EUSB device can only buffer 2 data packets, so the sector buffer is again full. The busy EUSB device again sends a NYET packet back to the host to indicate that the EUSB device is not yet ready to receive more data.

When the initial OUT request had a number of buffers equal to 4, then all requested data has been received by the EUSB device. The host ignores the NYET signal, since all data has been transmitted. The host then ends the OUT transaction.

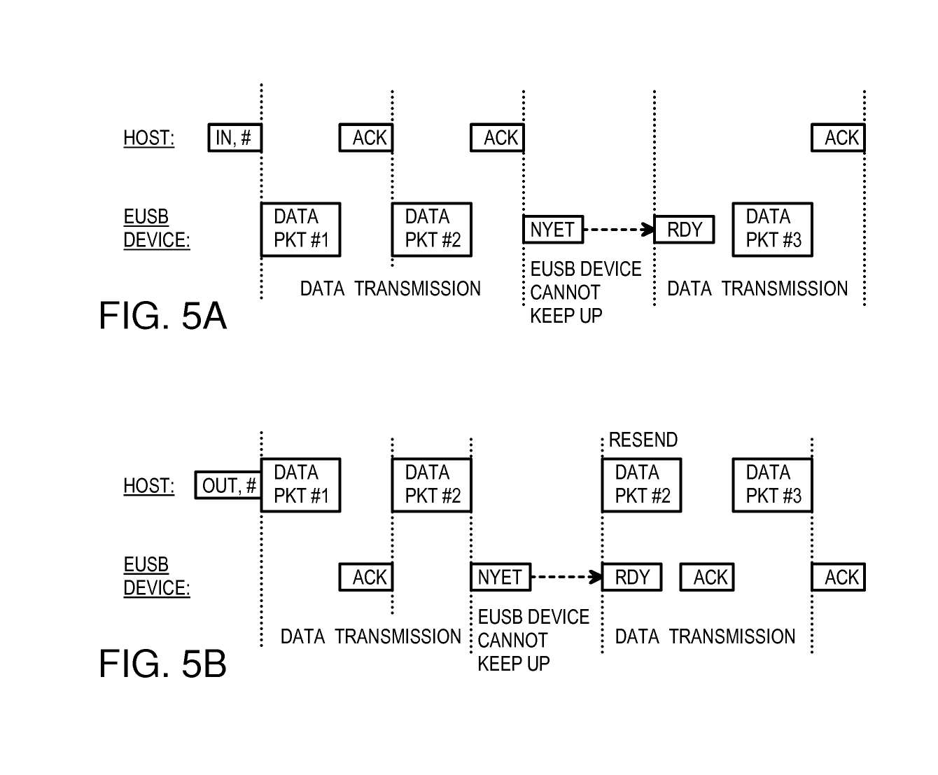

FIGS. 5A-B are packet-timing diagrams showing sequences of packets being sent to and received from the EUSB device. In FIG. 5A, the host sends a request to read flash memory from an EUSB device. The read request is embedded inside an IN packet that also contains a number of packets of data to read.

The EUSB device receives the IN packet and begins reading the data. The data may already be buffered in a cache or other buffer, such as when read-ahead caching occurs from an earlier read access. The EUSB device forms the first part of the requested data into data packet #1, which is sent back to the host.

The host sends an acknowledgement ACK to acknowledge receipt of data packet #1, and to request that the next packet be sent. The EUSB device reads the next data, forming data packet #2, which is also sent to the host.

The host sends another acknowledgement ACK to acknowledge receipt of data packet #2, and to request that the next packet be sent. However, the EUSB device cannot keep up with the pace of the host. The EUSB device sends a not yet NYET packet to the host since the next data is not yet ready.

The host responds to NYET signal by waiting. The host does not poll the EUSB device, but simply waits. After some time, the EUSB device catches up, and sends a ready RDY signal to the host. The EUSB device reads the next data, forming data packet #3, which is also sent to the host. The host sends an acknowledgement ACK to acknowledge receipt of data packet #3. Since only 3 packets were requested with the IN packet, the IN transaction ends.

In FIG. 5B, the host sends a request to write to flash memory in an EUSB device. The write request is embedded inside an OUT packet that also contains a number of packets of data to write. The host forms the first part of the write data into data packet #1, which is sent to the EUSB device after the OUT packet is sent.

The EUSB device receives the OUT packet and begins writing the data from data packet #1. The data may first be buffered in a cache or other buffer before writing to flash memory.

The EUSB device sends an acknowledgement ACK to acknowledge receipt of data packet #1, and to request that the next packet be sent. The host forms the next data into data packet #2, which is also sent to the EUSB device.

The EUSB device buffer is now full. The EUSB device cannot keep up with the pace of the host. The EUSB device sends a not yet NYET packet to the host since the sector buffer is full, and the EUSB device cannot receive more data.

The host responds to NYET signal by waiting. The host does not poll the EUSB device, but simply waits. After some time, the EUSB device catches up, and sends a ready RDY signal to the host. Since the EUSB device did not acknowledge receipt of data packet #2, the host re-sends data packet #2. The EUSB device buffers this data, and sends an acknowledgement ACK for the re-sent data packet #2.

The host forms data packet #3, which is also sent to the EUSB device. The EUSB device sends an acknowledgement ACK to acknowledge receipt of data packet #3. Since only 3 packets were requested with the OUT packet, the OUT transaction ends.

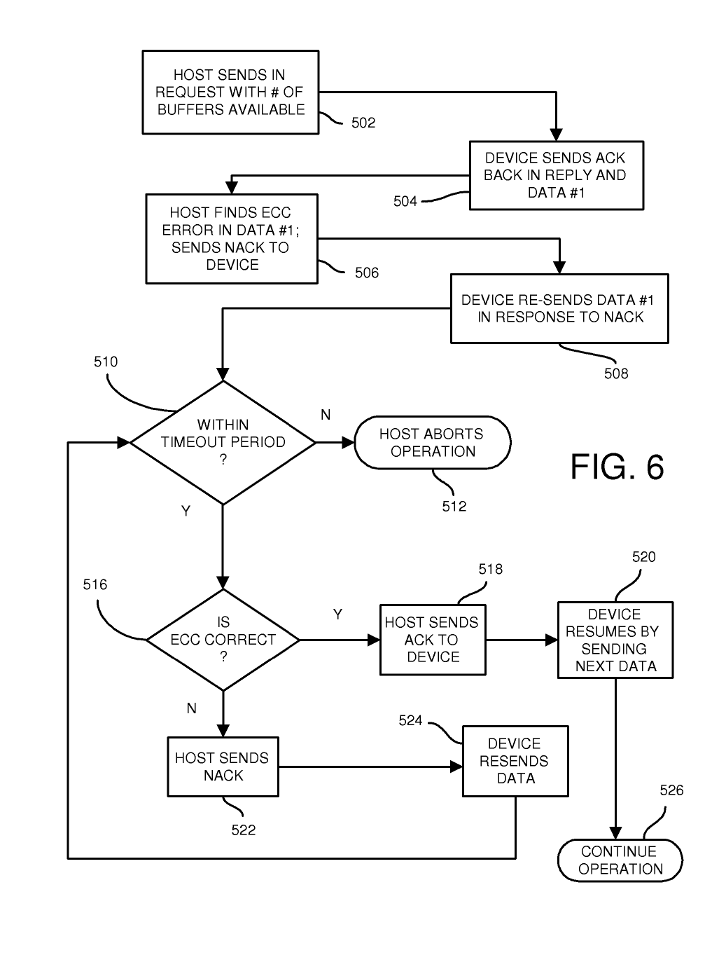

FIG. 6 is a flowchart of a basic IN protocol flow with not-acknowledge (NACK) to avoid polling. The EUSB host sends an IN request with the number of packet-buffers to transfer, step 502. The EUSB device sends back an acknowledgement ACK to the IN request and sends the first packet of data, step 504.

The host checks the transmitted data for errors by generating a CRC of the received data and comparing the generated CRC to a stored or transmitted CRC that was computed on the pre-transmitted data. When the CRC's mismatch, an error is detected. When the host finds an error using ECC, step 506, the host sends back a not-acknowledge (NACK) rather than an acknowledgement ACK.

The EUSB device responds to the NACK by re-sending the previous data, step 508. If the host does not receive the re-sent data within the timeout period, step 510, then the operation is aborted, step 512.

When the response is received within the timeout period, step 510, then the CRC or Error-Correction-Code (ECC) is checked on the re-sent data, step 516. When ECC is used rather than CRC, small errors may be corrected without requiring re-sending of the data. When the ECC indicates that the re-sent data is correct, step 516, then the host sends an acknowledgement ACK to the EUSB device, step 518. The EUSB device resumes by sending the next data packet, step 520, and the operation continues, step 526.

When the ECC indicates that the re-sent data has an error, step 516, then the host sends a not-acknowledgement NACK to the EUSB device, step 522. The EUSB device responds by re-sending the data, step 524, and the operation continues, step 510.

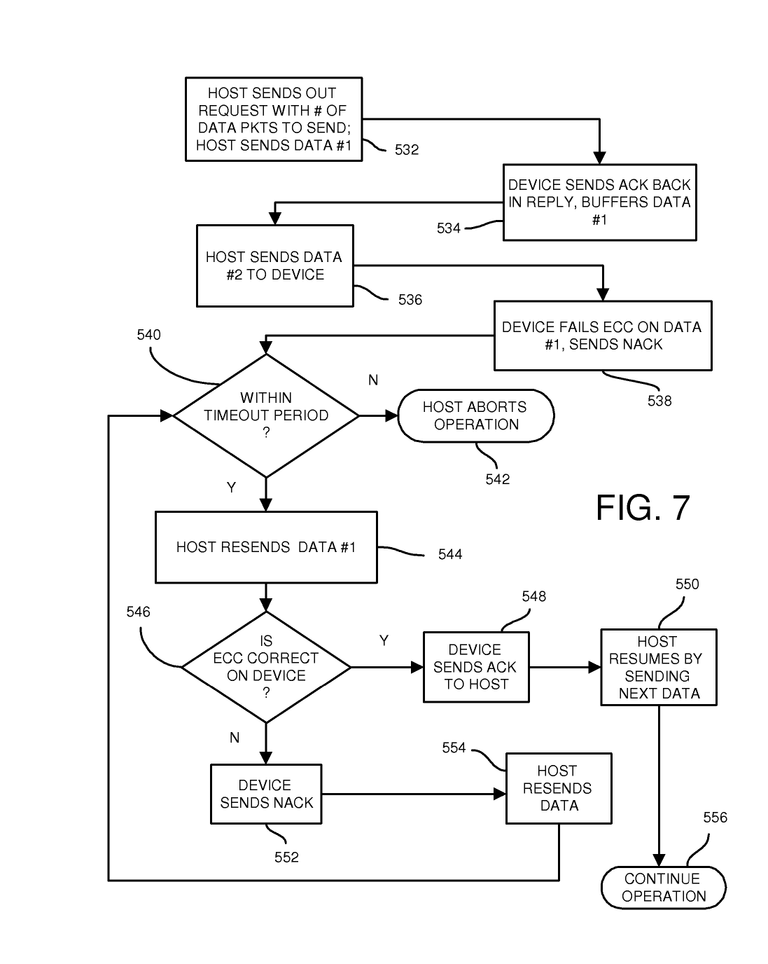

FIG. 7 is a flowchart of a basic OUT protocol flow with not-acknowledge (NACK) to avoid polling. The EUSB host sends an OUT request with the number of packet-buffers to transfer, step 532. The host also sends the first data for writing into the EUSB device, step 532.

The EUSB device buffers the first data packet and sends back an acknowledgement ACK to the OUT request, step 534. The host receives the ACK and sends the second data packet, data #2, step 536.

The EUSB device checks the transmitted data for errors by generating a CRC of the received data and comparing the generated CRC to a stored or transmitted CRC that was computed on the pre-transmitted data. When the CRC's mismatch, an error is detected. When the EUSB device finds an error using ECC, step 538, the EUSB device sends back a not-acknowledge (NACK) rather than an acknowledgement ACK.

If the host does not receive the response from the EUSB device within the timeout period, step 540, then the operation is aborted, step 542. Otherwise, when the host responds to the NACK by re-sending the previous data, step 544.

When the response is received within the timeout period, step 540, then the CRC or Error-Correction-Code (ECC) is checked by the EUSB device on the re-sent data, step 546. When the ECC indicates that the re-sent data is correct, step 546, then the EUSB device sends an acknowledgement ACK to the host, step 548. The host resumes by sending the next data packet, step 550, and the operation continues, step 556.

When the ECC indicates that the re-sent data has an error, step 546, then the EUSB device sends a not-acknowledgement NACK to the host, step 552. The host responds by re-sending the data, step 554, and the operation continues, step 540.

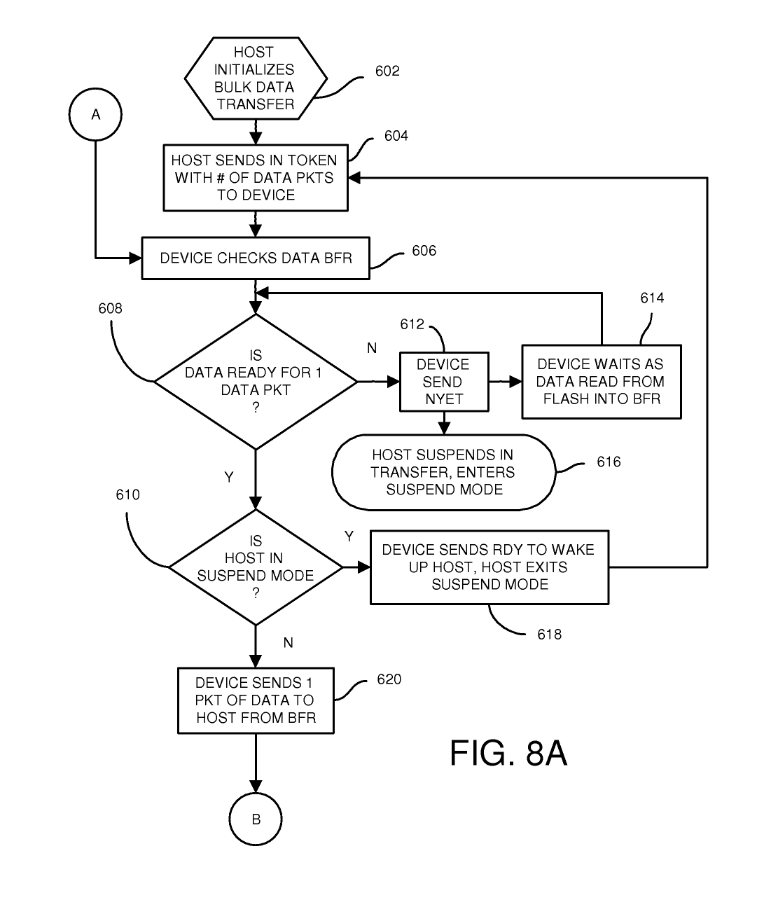

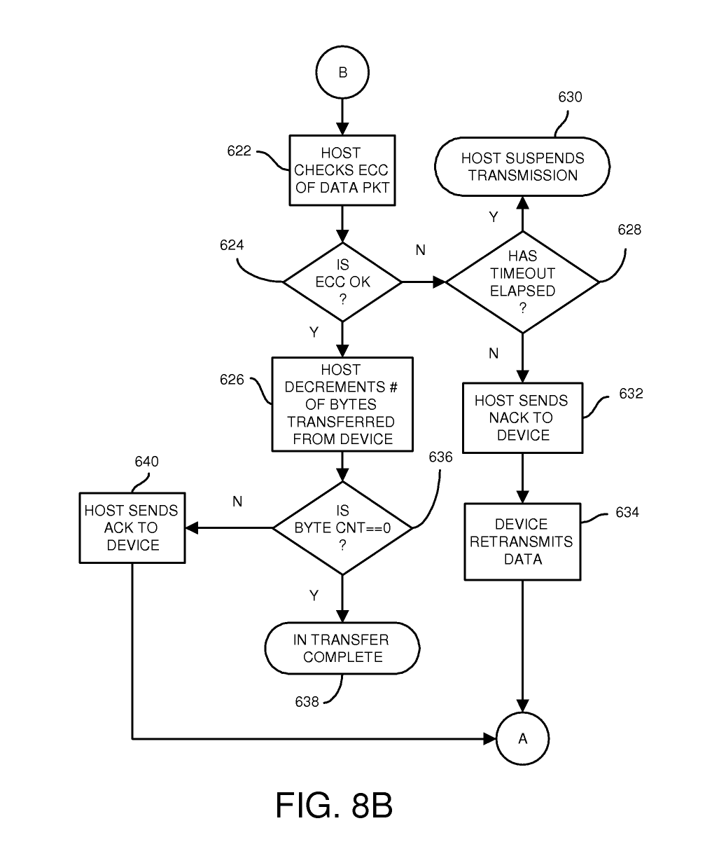

FIGS. 8A-B show a flowchart of an EUSB host suspending while an EUSB device is busy during an IN transfer. In FIG. 8A, an EUSB host initiates a transfer using the bulk-only-transfer mode, step 602. The host sends an IN token in a packet to the EUSB device, step 604, with the number of data packets as a parameter in the IN packet.

The EUSB device receives the IN packet and checks its sector buffer or other cache, step 606, to determine if the first packet of the requested data has already been read. The first packet could have been read earlier and cached in the sector buffer.

When the EUSB device has at least 1 packet ready, step 608, and the host is not in the sleep mode, step 610, then the EUSB device sends one packet of data from its sector buffer to the host, step 620. The flow then continues with FIG. 8B.

For many read operations, the data is not cached by the EUSB device. Step 608 fails because the requested data has not yet been read from the flash memory and loaded into the sector buffer. The EUSB device sends a not yet NYET signal to the host, step 612, and the host suspends the current IN transfer and enters a sleep mode to save power, step 616.

While the host is in the sleep mode, step 616, the EUSB device reads the requested data from its flash memory. The flash data is written into the sector buffer, step 614. When a full packet of flash data has been read from flash into the sector buffer, step 608, and the host is not in the sleep mode, step 610, then the EUSB device sends one packet of data from its sector buffer to the host, step 620. The flow then continues with FIG. 8B.

However, when the host is still in the sleep mode, step 610, then the EUSB device sends a ready RDY signal to the host, step 618. The ready signal causes the host to wake up from its sleep mode. Since the host has already suspended the current IN transfer, step 616, the host can re-start the current IN transfer from step 604 with another IN packet. However, this time the requested data should be in the sector buffer, and steps 608, 610 will pass, allowing the buffered data to be immediately transferred from the sector buffer to the host, step 620.

In FIG. 8B, after the first packet has been sent to the host in step 620, the host checks the data packet for errors, such as by generating a CRC, step 622. ECC code may also be used with error correction of small errors such as 1-bit errors. When the CRC or ECC is good, step 624, then the host decrements the bytes transfer count by the number of bytes received, step 626. When the byte count reaches zero, step 636, the transfer is completed, step 638. Otherwise, the host sends an acknowledgement ACK to the EUSB device, step 640, and the EUSB device sends the next data packet, using the flow from step 606 of FIG. 8A.

When the CRC or ECC is bad, step 624, and the timeout has elapsed, step 628, then the host suspends the current IN transfer, step 630. When timeout has not yet elapsed, step 628, the host sends a not-acknowledge NACK to the EUSB device, step 632, since the received data had an error. The EUSB device re-sends the current data packet, step 634, and the flow continues from step 606 of FIG. 8A.

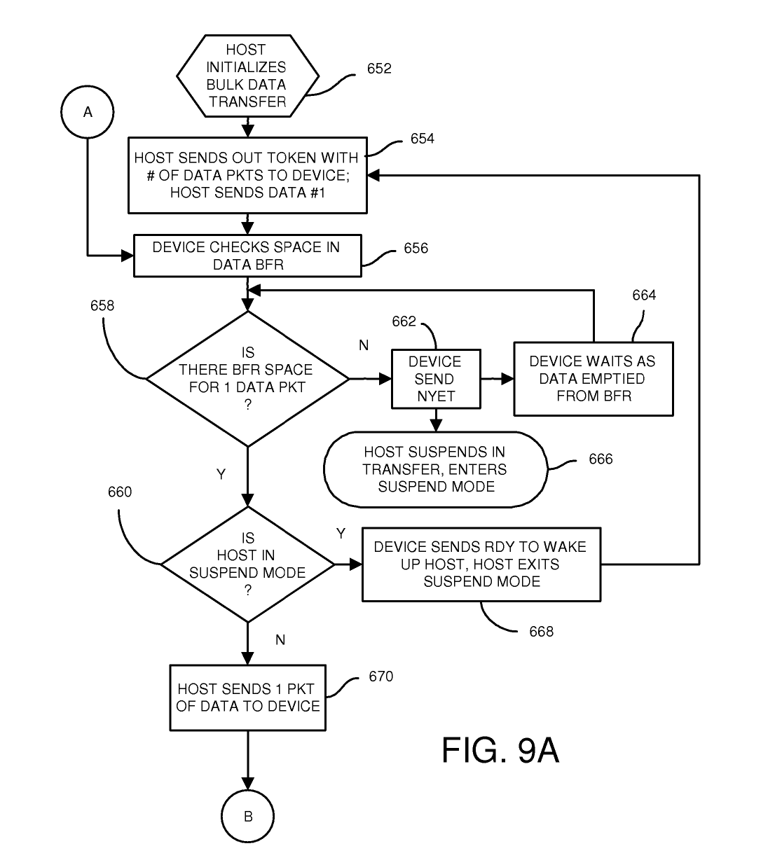

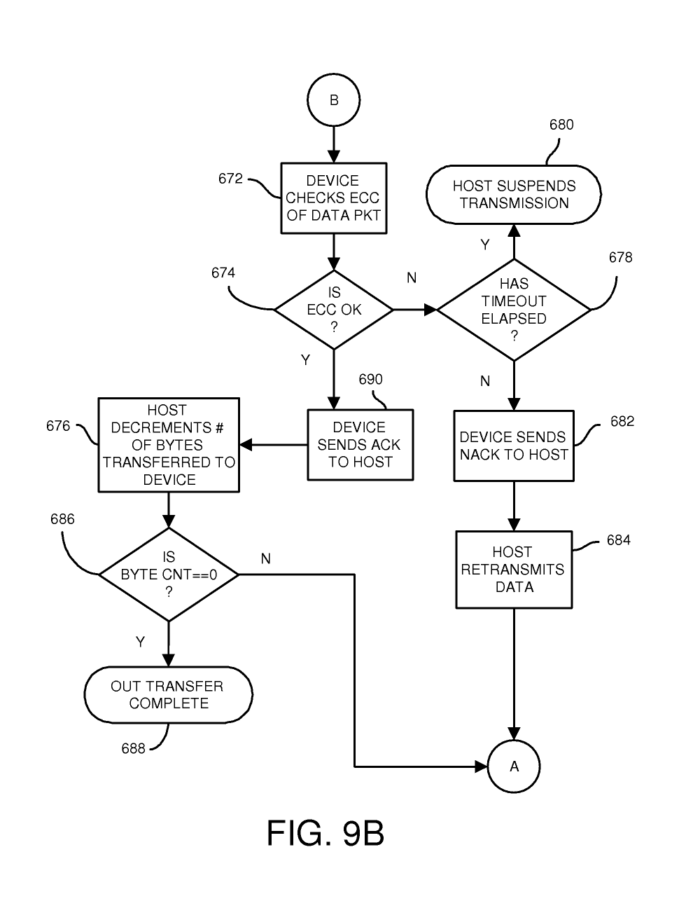

FIGS. 9A-B show a flowchart of an EUSB host suspending while an EUSB device is busy during an OUT transfer. In FIG. 9A, an EUSB host initiates a transfer using the bulk-only-transfer mode, step 652. The host sends an OUT token in a packet to the EUSB device, step 654, with the number of data packets as a parameter in the OUT packet.

The EUSB device receives the OUT packet and checks for empty space in its sector buffer or other cache, step 656, to determine if there is enough room to store the first packet.

When the EUSB device can accept at least 1 packet, step 658, and the host is not in the sleep mode, step 660, then the EUSB device receives one packet of data sent by the host, step 670. The packet is written into the sector buffer of the EUSB device. The flow then continues with FIG. 9B.

Write operations to flash tend to be relatively slow, so the sector buffer may already be full. Step 658 fails because the sector buffer is full of old data that has not yet been written into the flash memory and removed from the sector buffer. The EUSB device sends a not yet NYET signal to the host, step 662, and the host suspends the current OUT transfer and enters a sleep mode to save power, step 666.

While the host is in the sleep mode, step 666, the EUSB device writes data from its sector buffer into its flash memory. Eventually, enough data is written to flash that the sector buffer can store more data, step 664. When enough space is made for a full packet of flash data in the sector buffer, step 658, and the host is not in the sleep mode, step 660, then the EUSB device accepts one packet of data, which is written into its sector buffer, step 670. The flow then continues with FIG. 9B.

However, when the host is still in the sleep mode, step 660, then the EUSB device sends a ready RDY signal to the host, step 668. The ready signal causes the host to wake up from its sleep mode. Since the host has already suspended the current OUT transfer, step 666, the host can re-start the current OUT transfer from step 654 with another OUT packet. However, this time the sector buffer should have enough space to accept the data packet, and steps 658, 660 will pass, allowing the data from the host to be immediately written into the sector buffer, step 670.

In FIG. 9B, after the first packet has been received from the host in step 670, the EUSB device checks the data packet for errors, such as by generating a CRC, step 672. ECC code may also be used with error correction of small errors such as 1-bit errors. When the CRC or ECC is good, step 674, then the EUSB device sends an acknowledgement ACK to the host, step 690. The host decrements the bytes transfer count by the number of bytes received, step 676. When the byte count reaches zero, step 686, the transfer is completed, step 688. Otherwise, the host sends, and the EUSB device sends the next data packet, using the flow from step 656 of FIG. 9A.

When the CRC or ECC is bad, step 674, and the timeout has elapsed, step 678, then the host suspends the current OUT transfer, step 680. When timeout has not yet elapsed, step 678, the EUSB device sends a not-acknowledge NACK to the host, step 682, since the received data had an error. The host re-sends the current data packet, step 684, and the flow continues from step 656 of FIG. 9A.

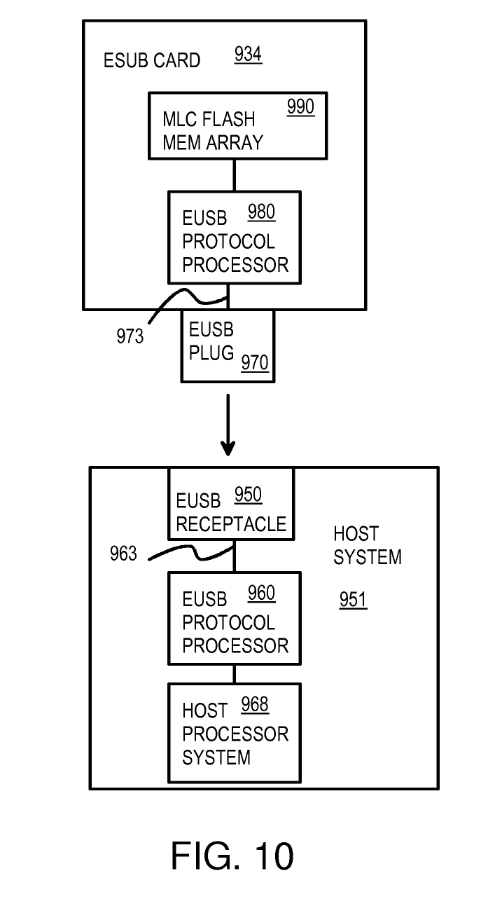

FIG. 10 is a block diagram of host with a EUSB receptacle that supports single-mode EUSB communication. EUSB card 934 could be plugged into EUSB receptacle 950 of host 951. Host 951 could be a cell phone or a digital camera, etc. EUSB receptacle 950 supports single-mode EUSB communication.

Host 951 has a processor system 968 for executing programs including EUSB management and no-polling programs. Single-personality bus interface 953 communicates processed data from processor system 968 using EUSB protocols.

EUSB card 934 is a EUSB device with a plug that supports EUSB communication. EUSB card 934 has processor system 980 for executing programs including device initializations and bus-response programs. Single-personality bus interface 973 communicates processed data from processor system 980 using the EUSB protocol to its plug 970. MLC flash memory 990 is a flash memory.

### Alternate Embodiments

Several other embodiments are contemplated by the inventors. Universal-Serial Bus (USB) can be extended to eliminate polling by using the NYET and other signals described herein. USB 2.0 may be modified, or other versions of USB may be modified.

The suspend or sleep mode of the host may be with respect to the target EUSB device, rather than to all USB devices. For example, the host may have several channels, each performing a transaction with a different EUSB device. Only channels to busy EUSB device are suspends; other channels from the host may continue operation. Since transfers that are suspended may be re-started by the host, the state of the current transfer does not have to be saved when the host goes into suspend mode. Not having to save state variables can reduce the complexity of the host's suspend mode

Instead of USB or other differential buses mentioned above, SD, MicroSD, MMC, or microMMC interfaces can also be applied in this invention. Rather than use SD buses, other buses may be used such as Memory Stick (MS), Compact Flash (CF), IDE bus, etc. Additional pins can be added or substituted for the SD data pins. A multi-bus-protocol chip could have an additional personality pin to select which bus interface to use, or could have programmable registers. Rather than have a SD microcontroller, a Memory Stick microcontroller could be substituted, for use with a memory-stick interface, etc.

While a sector size of 512 bytes has been described, the page size may have another size, such as 1K, 2K, 4K, 8K, etc. Flash blocks may have 4 pages, 8 pages, 64 pages, or some other number, depending on the physical flash chips and arrangement used.

While the invention has been described using an USB controller, a SD or MMC controller may be substituted. A combined controller that can function for both MMC and SD may also be substituted.

Mode logic could sense the state of a pin only at power-on rather than sense the state of a dedicated pin. A certain combination or sequence of states of pins could be used to initiate a mode change, or an internal register such as a configuration register could set the mode.

The microcontroller and USB components such as the protocol layers, bus interface, DMA, flash-memory controller, transaction manager, and other controllers and functions can be implemented in a variety of ways. Functions can be programmed and executed by the CPU or other processor, or can be implemented in dedicated hardware, firmware, or in some combination. Many partitioning of the functions can be substituted.

Data and commands may be routed in a variety of ways, such as through data-port registers, FIFO or other buffers, the CPU's registers and buffers, DMA registers and buffers, and flash registers and buffers. Some buffers may be bypassed or eliminated while others are used or present. Virtual or logical buffers rather than physical ones may also be used. Data may be formatted in a wide variety of ways.

The host can transfer standard USB commands and data transactions to the USB transceiver during a transaction, or may switch to EUSB mode to save power. Other transaction types or variations of these types can be defined for special purposes. These transactions may include a flash-controller-request, a flash-controller-reply, a boot-loader-request, a boot-loader-reply, a control-program-request, a control-program-reply, a flash-memory-request, and a flash-memory-reply. The flash-memory request/reply may further include the following request/reply pairs: flash ID, read, write, erase, copy-back, reset, page-write, cache-write and read-status.

The host may be a personal computer (PC), a portable computing device, a digital camera, a phone, a personal digital assistant (PDA), or other electronic device. The partition of SRAM among various functions could change over time.

Wider or narrower data buses and flash-memory blocks could be substituted, such as 4, 5, 8, 16, 32, 64, 128, 256-bit, or some other width data channels. Alternate bus architectures with nested or segmented buses could be used internal or external to the microcontroller. Two or more internal and flash buses can be used in the USB flash microcontroller to increase throughput. More complex switch fabrics can be substituted for the internal buses.

The flash mass storage chips or blocks can be constructed from any flash technology including multi-level-logic (MLC) memory cells. Data striping could be used with the flash mass storage blocks in a variety of ways, as can parity and error-correction code (ECC). Data re-ordering can be adjusted depending on the data arrangement used to prevent re-ordering for overlapping memory locations. An hub or switch could be integrated with other components or could be a stand-alone chip. The hub/switch could also be integrated with the USB single-chip flash device. While a single-chip device has been described, separate packaged chips or die may be stacked together while sharing I/O pins, or modules may be used.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another a tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. An Extended Universal-Serial Bus (EUSB) device comprising:
a EUSB analog front end having an input connection to a first pair of differential lines and having an output connection to a second pair of differential lines;
a serial-parallel converter, coupled to the EUSB analog front end to receive an input serial bitstream received over the first pair of differential lines, and coupled to output an output serial bitstream for transmission over the second pair of differential lines, for converting the input serial bitstream into input parallel words, and for converting output parallel words into the output serial bitstream;
a frame processor for adding frame bits to the output parallel words, and for removing frame bits from the input parallel words;
an error-code generator/checker for generating a generated checksum for the input parallel words and for signaling an error when the generated checksum mismatches a transmitted checksum in the input parallel words, and for generating a checksum stored with the output parallel words;
a bulk-only-transport layer processor for inserting a header for a EUSB protocol into the output parallel words, and for extracting the header from the input parallel words;
a flash memory for storing data in non-volatile flash-memory cells wherein data is retained when power is disconnected;
a flash interface for accessing the flash memory;
a sector buffer for storing the output parallel words read from the flash memory by the flash interface, and for storing input parallel words before writing to the flash memory by the flash interface; and
a microcontroller that generates a not-yet signal that is transmitted to a host over the second pair of differential lines when the sector buffer does not yet contain requested data that is waiting to be read from the flash memory,
whereby the not-yet signal is transmitted over the second pair of differential lines when the requested data is waiting to be read from the flash memory.

2. The Extended Universal-Serial Bus (EUSB) device of claim 1 further comprising:
a full indicator, coupled to the sector buffer, for activating the microcontroller to generate the not-yet signal when the sector buffer is full and cannot accept data received over the first pair of differential lines.

3. The Extended Universal-Serial Bus (EUSB) device of claim 2 wherein the full indicator also activates the microcontroller to generate the not-yet signal when the sector buffer is not full, but has insufficient space for accepting a packet of data received over the first pair of differential lines;
wherein the packet of data is for writing to the flash memory.

4. The Extended Universal-Serial Bus (EUSB) device of claim 3 further comprising:
a ready signal sent to the host over the second pair of differential lines, wherein the microcontroller generates the ready signal when the sector buffer contains requested data after the not-yet signal was generated;
wherein the microcontroller also generates the ready signal when sufficient space is made available in the sector buffer for accepting the packet after the not-yet signal was generated.

5. The Extended Universal-Serial Bus (EUSB) device of claim 2 wherein the not-yet signal is embedded in a status packet transmitted over the second pair of differential lines.

6. The Extended Universal-Serial Bus (EUSB) device of claim 5 wherein the not-yet signal is a flag in a header in the status packet transmitted over the second pair of differential lines.

7. The Extended Universal-Serial Bus (EUSB) device of claim 2 further comprising:
an acknowledgement generator, coupled to the error-code generator/checker, for generating an acknowledgement to the host that is sent to the second pair of differential lines when the error-code generator/checker matches the generated checksum to the transmitted checksum.

8. The Extended Universal-Serial Bus (EUSB) device of claim 7 further comprising:
a not-acknowledgement generator, coupled to the error-code generator/checker, for generating a not-acknowledgement to the host that is sent to the second pair of differential lines when the error-code generator/checker determines that the generated checksum mismatches the transmitted checksum.

9. A method for avoiding polling when accessing an extended Universal-Serial Bus (EUSB) device comprising:
sending a request for a new transaction from a host to an EUSB device over a first differential pair of lines by generating physical electrical signals;
sending an acknowledgement to the host over a second differential pair of lines in response to the request for the new transaction by generating physical electrical signals;
sending a first data packet to the host over the second differential pair of lines in response to the request for the new transaction;
receiving an acknowledgement for the first data packet over the first differential pair of lines;
sending a not-yet signal to the host in response to the EUSB device not being ready to send a second data packet;
the host entering a suspend mode in response to the not-yet signal from the EUSB device;
reading second data from a memory on the EUSB device and loading the second data into the second data packet;
sending a ready signal to the host when the second data is loaded into the second data packet;
the host awakening from the suspend mode in response to the ready signal from the EUSB device;
sending the second data packet over the second differential pair of lines to the host; and
receiving an acknowledgement for the second data packet over the first differential pair of lines;
whereby the host enters the suspend mode in response to the not-yet signal generated by the EUSB device when the second data packet is not yet loaded with the second data.

10. The method of claim 9 wherein the host avoids polling the EUSB device by entering the suspend mode and waiting for the ready signal from the EUSB device.

11. The method of claim 10 wherein the not-yet signal and the ready signal are sent over the second differential pair of lines from the EUSB device to the host.

12. The method of claim 11 further comprising:
the host aborting the new transaction when the ready signal is not generated within a timeout period of time.

13. The method of claim 11 further comprising:
generating a generated checksum from the first data packet received by the host;
sending a not-acknowledgement over the first differential pair of lines when the generated checksum mismatches a transmitted checksum in the first data packet;
resending the first data packet to the host over the second differential pair of lines in response to the not-acknowledgement,
whereby data is resent in response to the not-acknowledgement generated by checksum mismatching.

14. The method of claim 13 wherein forming the second data packet comprises forming a Universal-Serial Bus (USB) packet.

15. An Extended Universal-Serial Bus (EUSB) system comprising:
an EUSB host;
an EUSB device;
a first pair of differential lines coupled between the EUSB host and the EUSB device, for carrying serial packets from the EUSB host to the EUSB device;
a second pair of differential lines coupled between the EUSB host and the EUSB device, for carrying serial packets from the EUSB device to the EUSB host;
a EUSB bulk-only-transfer and command transaction layer on the EUSB host, for receiving a not-yet signal sent by the EUSB device over the second pair of differential lines;
a suspend mode of the EUSB host, activated when the EUSB bulk-only-transfer and command transaction layer receives the not-yet signal;
wherein the EUSB host suspends sending serial packets to the EUSB device during the suspend mode, the EUSB host not polling the EUSB device in response to the not-yet signal;
flash memory means, on the EUSB device, for storing data in non-volatile flash-memory cells wherein data is retained when power is disconnected;
flash interface means, on the EUSB device, for accessing the flash memory means;
sector buffer means, on the EUSB device, for storing output parallel words read from the flash memory means by the flash interface means, and for storing input parallel words before writing to the flash memory means by the flash interface means; and
microcontroller means, on the EUSB device, for generating the not-yet signal that is transmitted to the EUSB host over the second pair of differential lines when the sector buffer means does not yet contain requested data that is waiting to be read from the flash memory means,
whereby the not-yet signal transmitted to the EUSB host when the requested data is waiting to be read from the flash memory means causes the EUSB host to enter the suspend mode and not poll the EUSB device.

16. The Extended Universal-Serial Bus (EUSB) system of claim 15 wherein power consumed by the EUSB host is reduced when the suspend mode is activated by the not-yet signal; and
wherein power consumed by the EUSB device is reduced when the EUSB host avoids polling during the suspend mode activated by the not-yet signal.

17. The Extended Universal-Serial Bus (EUSB) system of claim 15 wherein the EUSB device further comprises:
EUSB analog front end means for sending differential signals on differential lines, the EUSB analog front end means having an input connection to the first pair of differential lines and having an output connection to the second pair of differential lines;
serial-parallel converter means, coupled to the EUSB analog front end means to receive an input serial bitstream received over the first pair of differential lines, and coupled to output an output serial bitstream for transmission over the second pair of differential lines, for converting the input serial bitstream into input parallel words, and for converting output parallel words into the output serial bitstream;
frame processor means for adding frame bits to the output parallel words, and for removing frame bits from the input parallel words;
error-code generator/checker means for generating a generated checksum for the input parallel words and for signaling an error when the generated checksum mismatches a transmitted checksum in the input parallel words, and for generating a checksum stored with the output parallel words; and
bulk-only-transport layer processor means for inserting a header for a EUSB protocol into the output parallel words, and for extracting the header from the input parallel words.

18. The Extended Universal-Serial Bus (EUSB) system of claim 17 further comprising:
full indicator means, coupled to the sector buffer means, for activating the microcontroller means to generate the not-yet signal when the sector buffer means is full and cannot accept data received over the first pair of differential lines.

19. The Extended Universal-Serial Bus (EUSB) system of claim 18 wherein the full indicator means also activates the microcontroller means to generate the not-yet signal when the sector buffer means is not full, but has insufficient space for accepting a packet of data received over the first pair of differential lines;
wherein the packet of data is for writing to the flash memory means.

20. The Extended Universal-Serial Bus (EUSB) system of claim 17 further comprising:
timeout means, on the EUSB host, for ending a current transaction to the EUSB device when the EUSB host has been suspended for more than a timeout period of time, and for re-initiating the current transaction as a new transaction.
